(19) United States
(12) Patent Application Publication
(10) Pub. No.: US 2026/0004795 A1
(43) Pub. Date: Jan. 1, 2026

(54) SPEECH ENHANCEMENT MODEL TRAINING METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Feng BAO, Shenzhen (CN)

(73) Assignee: Tencent Technology (Shenzhen) Company Limited, Shenzhen (CN)

(21) Appl. No.: 19/322,129

(22) Filed: Sep. 8, 2025

Related U.S. Application Data
(63) Continuation of application No. PCT/CN2024/099475, filed on Jun. 17, 2024.

(30) Foreign Application Priority Data
Aug. 17, 2023 (CN) 202311042065.8

(51) Int. Cl. G10L 21/0232; G10L 21/0264; G10L 25/30

(52) U.S. Cl. CPC G10L 21/0232; G10L 21/0264; G10L 25/30

(57) ABSTRACT

This present disclosure relates to a speech enhancement model training method and apparatus, an electronic device, and a storage medium. The method includes: extracting a first audio feature of a to-be-enhanced speech signal through an input layer in each instance of iterative training of an initial speech enhancement model; performing frequency band compression on the first audio feature through a frequency band compression layer, to obtain a dimensionality-reduced second audio feature; performing, through a feature mapping layer, feature mapping on the second audio feature by using a cyclic iteration manner, to obtain a third audio feature, a quantity of output channels of the feature mapping layer increasing progressively in a cyclic iteration process; and inputting the third audio feature to an output layer, to obtain estimated gain information, and performing parameter adjustment on the initial speech enhancement model with reference to true gain information.

### RELATED APPLICATION

This present application is a continuation of and claims the benefit of priority to PCT Application No. PCT/CN2024/099475, filed Jun. 17, 2024, and entitled SPEECH ENHANCEMENT MODEL TRAINING METHOD AND APPARATUS, DEVICE, MEDIUM, AND PROGRAM PRODUCT, which is based on and claims the benefit of priority to Chinese Patent Application No. 202311042065.8, entitled “SPEECH ENHANCEMENT MODEL TRAINING METHOD AND APPARATUS, DEVICE, MEDIUM, AND PROGRAM PRODUCT” filed with the China National Intellectual Property Administration on Aug. 17, 2023, which are incorporated by reference in their entireties.

### FIELD OF THE TECHNOLOGY

This application relates to the field of artificial intelligence technologies, and in particular, to speech enhancement.

### BACKGROUND OF THE DISCLOSURE

With the rapid development of deep learning technologies, a speech enhancement model is widely applied to a speech denoising scenario. By using the speech enhancement model, a valid signal can be extracted from an original speech signal, thereby suppressing and reducing interference caused by a noise signal.

In the related art, the speech enhancement model usually includes a plurality of layers of neural networks, such as a convolutional neural network (CNN), a long short-term memory (LSTM), and a gate recurrent unit (GRU). This causes the speech enhancement model to have high operation complexity.

Therefore, in a real-time communication scenario (such as an online conference), it is difficult to meet a real-time operation requirement by using the speech enhancement model to perform speech enhancement. Consequently, a communication delay is caused, and a communication experience is affected.

### SUMMARY

Embodiments of the present disclosure provide a speech enhancement model training method and apparatus, an electronic device, a storage medium, and a program product, to ensure a processing effect of a speech enhancement model and reduce operation complexity to improve an operation speed, thereby meeting a real-time operation requirement and enhancing a communication experience.

In an aspect, an embodiment of the present disclosure provides a speech enhancement model training method, including:

obtaining a training sample set, each training sample including: a sample speech signal and a corresponding noise-containing speech signal;

performing iterative training on an initial speech enhancement model based on the training sample set, to obtain a trained speech enhancement model, the initial speech enhancement model including an input layer, a frequency band compression layer, a feature mapping layer, and an output layer, each training process including:

respectively performing feature extraction on the sample speech signal and the noise-containing speech signal of a selected training sample through the input layer, and then performing fusion, to obtain a first audio feature;

performing frequency band compression on the first audio feature through the frequency band compression layer, to obtain a second audio feature, a quantity of feature dimensions of the second audio feature being less than a quantity of feature dimensions of the first audio feature;

performing, through the feature mapping layer, feature mapping on the second audio feature by using a cyclic iteration manner until a number of iterations reaches a set number of instances of mapping, to obtain a third audio feature, a quantity of output channels of the feature mapping layer progressively increasing in a cyclic iteration process; and

inputting the third audio feature to the output layer, to obtain estimated gain information, and performing parameter adjustment on the initial speech enhancement model based on a difference between the estimated gain information and corresponding true gain information.

In an aspect, an embodiment of the present disclosure provides a speech enhancement method, including:

inputting a to-be-enhanced speech signal to a speech enhancement model obtained by training by the above speech enhancement model training method, to obtain estimated gain information; and

performing speech enhancement on the to-be-enhanced speech signal based on the estimated gain information.

In an aspect, an embodiment of the present disclosure provides a speech enhancement model training apparatus, including:

an obtaining unit, configured to obtain a training sample set, each training sample including: a sample speech signal and a corresponding noise-containing speech signal;

a training unit, configured to perform iterative training on an initial speech enhancement model based on the training sample set, to obtain a trained speech enhancement model, the initial speech enhancement model including an input layer, a frequency band compression layer, a feature mapping layer, and an output layer, each training process including:

respectively performing feature extraction on the sample speech signal and the noise-containing speech signal of a selected training sample through the input layer, and then performing fusion, to obtain a first audio feature;

performing frequency band compression on the first audio feature through the frequency band compression layer, to obtain a second audio feature, a quantity of feature dimensions of the second audio feature being less than a quantity of feature dimensions of the first audio feature;

performing, through the feature mapping layer, feature mapping on the second audio feature by using a cyclic iteration manner until a number of iterations reaches a set number of instances of mapping, to obtain a third audio feature, a quantity of output channels of the feature mapping layer progressively increasing in a cyclic iteration process; and

inputting the third audio feature to the output layer, to obtain estimated gain information, and performing parameter adjustment on the initial speech enhancement model based on a difference between the estimated gain information and corresponding true gain information.

In an aspect, an embodiment of the present disclosure provides a speech enhancement apparatus, including:

an inputting unit, configured to input a to-be-enhanced speech signal to a speech enhancement model obtained by training by the above speech enhancement model training method according, to obtain estimated gain information; and

a speech enhancement unit, configured to perform speech enhancement on the to-be-enhanced speech signal based on the estimated gain information.

In an aspect, an embodiment of the present disclosure further provides an electronic device, including a processor and a memory, the memory having a computer program stored therein, and the computer program, when executed by the processor, causing the processor to perform the operations of any one of the above speech enhancement methods or the operations of any one of the above speech enhancement model training methods.

In an aspect, an embodiment of the present disclosure provides a computer-readable storage medium, including a computer program which, when executed on an electronic device, is configured for causing the electronic device to perform the operations of any one of the above speech enhancement methods or the operations of any one of the above speech enhancement model training methods.

In an aspect, an embodiment of the present disclosure provides a computer program product, including a computer program which is stored in a computer-readable storage medium. When a processor of an electronic device reads the computer program from the computer-readable storage medium, the processor executes the computer program to cause the electronic device to perform the operations of any one of the above speech enhancement methods or the operations of any one of the above speech enhancement model training methods.

The embodiments of the present disclosure at least have the following beneficial effects:

In the embodiments of the present disclosure, in each round of training of the initial speech enhancement model, the first audio feature of each training sample is first extracted. Then, to reduce subsequent operation complexity, the frequency band compression is performed on the first audio feature through the frequency band compression layer, to obtain the dimensionality-reduced second audio feature. The second audio feature is inputted to the feature mapping layer by cyclic iteration, and quantities of output channels in a plurality of iterations progressively increase. In this way, a depth of feature mapping and a parameter amount can be increased without adding a model structure, to enhance a model training effect. Finally, the estimated gain information is obtained based on the third audio feature outputted by the feature mapping layer. Therefore, in the embodiments of the present disclosure, feature dimensionality reduction is performed through the frequency band compression layer, thereby greatly reducing the subsequent operation complexity. In addition, due to the cyclic iteration of the feature mapping layer, the model training effect is enhanced, so that the trained speech enhancement model ensures a processing effect and reduces the operation complexity to improve an operation speed, thereby meeting a real-time operation requirement and enhancing a communication experience.

Other features and advantages of the present disclosure will be elaborated in subsequent specification, and will be partially apparent from the specification or understood through the implementation of the present disclosure. The objectives and other advantages of the present disclosure can be achieved and obtained through the structures specifically pointed out in the specification, claims, and accompanying drawings.

### BRIEF DESCRIPTION OF THE DRAWINGS

FIG. 1 is an example schematic diagram of an application scenario of a speech enhancement method according to an embodiment of the present disclosure.

FIG. 2 is an example schematic structural diagram of an initial speech enhancement model according to an embodiment of the present disclosure.

FIG. 3 is an example flowchart of a speech enhancement model training method according to an embodiment of the present disclosure.

FIG. 4 is an example schematic structural diagram of an input layer of an initial speech enhancement model according to an embodiment of the present disclosure.

FIG. 5A is an example schematic diagram of a quantity of output channels of a feature mapping layer of an initial speech enhancement model according to an embodiment of the present disclosure.

FIG. 5B is an example schematic structural diagram of a feature mapping layer of an initial speech enhancement model according to an embodiment of the present disclosure.

FIG. 6 is an example schematic structural diagram of an output layer of an initial speech enhancement model according to an embodiment of the present disclosure.

FIG. 7A is an example schematic diagram of a speech enhancement model training process according to an embodiment of the present disclosure.

FIG. 7B is an example schematic diagram of another speech enhancement model training process according to an embodiment of the present disclosure.

FIG. 8 is an example flowchart of a speech enhancement method according to an embodiment of the present disclosure.

FIG. 9 is an example schematic logic diagram of a speech enhancement method according to an embodiment of the present disclosure.

FIG. 10 is an example schematic diagram of an original speech signal and an enhanced speech signal according to an embodiment of the present disclosure.

FIG. 11 is an example schematic structural diagram of a speech enhancement model training apparatus according to an embodiment of the present disclosure.

FIG. 12 is an example schematic structural diagram of a speech enhancement apparatus according to an embodiment of the present disclosure.

FIG. 13 is an example schematic structural diagram of hardware composition of an electronic device to which an embodiment of the present disclosure is applied.

FIG. 14 is an example schematic structural diagram of hardware composition of another electronic device to which an embodiment of the present disclosure is applied.

### DESCRIPTION OF EMBODIMENTS

To make the objectives, technical solutions, and advantages of the embodiments of the present disclosure clearer, the technical solutions of the present disclosure will be clearly and completely described below with reference to the accompanying drawings in the embodiments of the present disclosure. Apparently, the described embodiments are merely a part of embodiments in the technical solutions of the present disclosure rather than all of the embodiments. Based on the embodiments recorded in the document of the present disclosure, all other embodiments obtained by a person of ordinary skill in the art without making creative efforts shall fall within the protection scope of the technical solutions of the present disclosure.

The following describes some concepts in the embodiments of the present disclosure.

Speech enhancement: It is a technology for extracting a useful speech signal from a noise background after a speech signal is interfered with or even overwhelmed by various noises, to suppress or reduce noise interference.

Convolutional neural network (CNN): It is a type of feedforward neural network including convolutional computation and having a deep structure. The CNN includes a convolutional layer, a pooling layer, and a fully connected layer. The convolutional layer is responsible for extracting a local feature of input data. The pooling layer is configured for greatly reducing a parameter magnitude (dimensionality reduction). The fully-connected layer is configured for outputting a desired result.

Attention mechanism: It derives from research on human vision. In cognitive science, due to a bottleneck in information processing, humans may selectively pay attention to a part of all information, and ignore other visible information. The mechanism is usually referred to as an attention mechanism. The attention mechanism may enable a neural network to have a capability of focusing on an input (or feature) subset of the neural network, and select a particular input. In a case of limited computing capability, the attention mechanism is a resource allocation solution that is a main means for resolving an information overload problem, to allocate a computing resource to a more important task.

Acoustic perceptual scale: A sensitivity of human ears to speech changes with a change in a frequency, and the sensitivity and the frequency are not simply in a linearly direct proportional relationship, but are approximately in a logarithmic relationship. To better approximate a pickup feature of the human ears, nonlinear transformation is usually performed on a frequency of a speech to an acoustic perceptual scale, to extract a speech feature. The acoustic perception scale includes an equivalent rectangular bandwidth (ERB) scale, a Mel scale, a bark scale, or the like, which are all psychoacoustics measurement methods and are configured for describing nonlinear transformation of the human ears on frequency perception. The psychoacoustics is an interdisciplinary field that studies a relationship between an objective parameter (such as a frequency, an amplitude, and a phase) and a subjective feeling (such as loudness, tone, and timbre) of a sound.

The term “exemplary” used below means “used as an example, an embodiment, or illustration”. Any embodiment described as being “exemplary” is not necessarily construed as being superior to or better than another embodiment.

The terms such as “first” and “second” herein are used only for the purpose of description, and are not understood as indicating or implying the relative importance or implicitly specifying the quantity of the indicated technical features. Thus, features defined as “first” and “second” explicitly or implicitly include one or more of the features. In the description of the embodiments of the present disclosure, “plurality” means two or more, unless otherwise specified.

Artificial intelligence (AI) is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

AI is a comprehensive discipline, and relates to a wide range of fields including both hardware-stage technologies and software-stage technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a natural language processing technology, and machine learning/deep learning. With the development and progress of artificial intelligence, artificial intelligence is studied and applied to many fields, for example, common smart home, smart customer service, virtual assistance, smart speakers, intelligent sales and marketing, unmanned driving, automatic driving, robots, and intelligent medical treatment. It is believed that with the further development of future technologies, artificial intelligence will be applied to more fields and play an increasingly important role.

Machine learning (ML) is a multi-field interdiscipline that spans a plurality of disciplines such as probability theory, statistics, approximation theory, convex analysis, and algorithm complexity theory. ML specializes in studying how a computer simulates or implements a human learning behavior to obtain new knowledge or skills, and reorganize an existing knowledge structure, so as to keep improving its performance.

Machine learning is the core of artificial intelligence, which is a basic solution for enabling a computer to be intelligent. Deep learning is the core of machine learning, which is a technology for implementing machine learning. Machine learning generally includes technologies such as deep learning, reinforcement learning, transfer learning, and inductive learning. The deep learning includes technologies such as a mobile visual neural network (Mobilenet), a convolutional neural network (CNN), a deep confidence network, a recursive neural network, an autoencoder, and a generative adversarial network.

In the embodiments of the present disclosure, an initial speech enhancement model may be trained based on the deep learning technology in the machine learning, to obtain a trained speech enhancement model, and then the speech enhancement model is employed to perform speech enhancement.

With the development and progress of artificial intelligence, artificial intelligence is studied and applied to many fields, for example, common smart home, smart customer service, virtual assistance, smart speakers, intelligent sales and marketing, unmanned driving, automatic driving, robots, and intelligent medical treatment. It is believed that with the further development of future technologies, artificial intelligence will be applied to more fields and play an increasingly important role.

The cloud technology is a hosting technology that unifies hardware, software, network, and other resources in a wide area network or a local area network to achieve computation, storage, processing, and sharing of data.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology will become an important support. The background service of a technical network system requires a large number of computing and storage resources, for example, video websites, image websites, and more portal websites. With the rapid development and application of the Internet industry, each item may have its own recognition mark in the future, and the recognition marks need to be transmitted to a backend system for logical processing. Data of different levels is processed separately, and all kinds of industry data require a strong system support, which can be achieved only through the cloud computing. In the embodiments of the present disclosure, a speech enhancement model may be trained through cloud computing.

The following briefly introduces a design idea of the embodiments of the present disclosure.

In the related art, a speech enhancement model usually includes a plurality of layers of neural networks, such as a convolutional neural network (CNN), a long short-term memory (LSTM), and a gate recurrent unit (GRU). This causes the speech enhancement model to have high operation complexity. Therefore, in a real-time communication scenario (such as an online conference), it is difficult to meet a real-time operation requirement by using the speech enhancement model to perform speech enhancement. Consequently, a communication delay is caused, and a communication experience is affected.

In view of this, the embodiments of the present disclosure provide a speech enhancement model training method and apparatus, an electronic device, and a storage medium. When an initial speech enhancement model is trained, to reduce computing complexity, a feature dimension is reduced by frequency band compression, and through a feature mapping layer of the initial speech enhancement model, feature mapping is performed on an input feature by using a cyclic iteration manner. Meanwhile, a quantity of output channels of the feature mapping layer progressively increases. In this way, a depth of feature mapping and a parameter amount can be increased without adding a model structure, thereby ensuring a model training effect. Therefore, a speech enhancement model obtained by training in the embodiments of the present disclosure can ensure a processing effect and reduce operation complexity to improve an operation speed, thereby meeting a real-time operation requirement and enhancing a communication experience.

The following describes the preferred embodiments of the present disclosure with reference to the accompanying drawings of this specification. The preferred embodiments described herein are merely intended to describe and explain the present disclosure, but are not intended to limit the present disclosure. In addition, the embodiments of the present disclosure and features in the embodiments may be mutually combined without conflict.

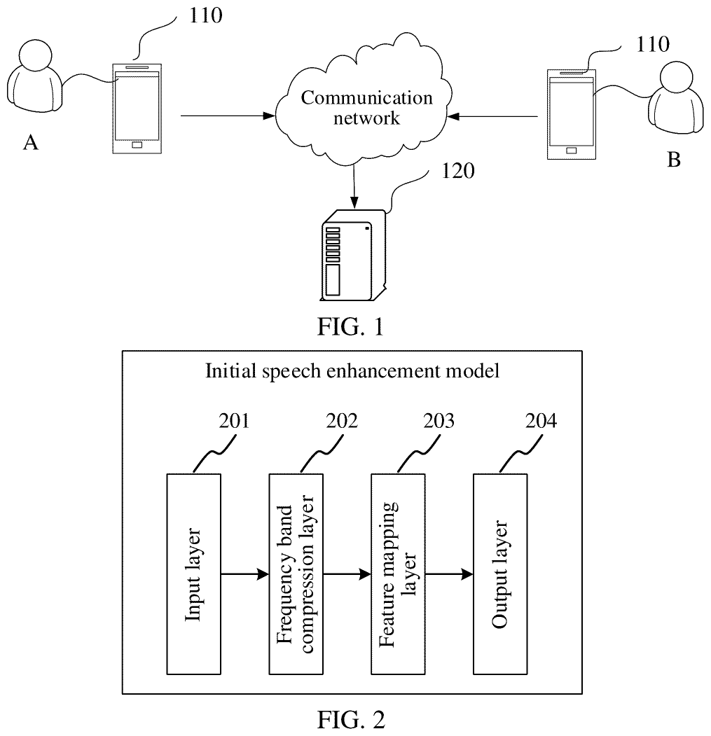

FIG. 1 is a schematic diagram of an application scenario according to an embodiment of the present disclosure. The diagram of the application scenario includes a terminal device 110 and a server 120.

In this embodiment of the present disclosure, the terminal device 110 includes, but is not limited to, a mobile phone, a tablet computer, a notebook computer, a desktop computer, a desktop computer, a smart speaker, a smart watch, an e-book reader, a smart speech interaction device, a smart home appliance, an in-vehicle terminal, or other devices. A client related to real-time communication may be installed on the terminal device. The client may be software (for example, conference software and social software), or may be a web page, a mini program, or the like. The server 120 may be a backend server corresponding to software, a web page, a mini program, or the like, or a server specially for speech enhancement. The present disclosure does not impose a specific limitation. The server 120 may be an independent physical server, or may be a server cluster or a distributed system formed by a plurality of physical servers, or may be a server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms.

In some implementations, the terminal device 110 and the server 120 may be directly or indirectly connected in a wired or wireless communication manner. The present disclosure does not impose a specific limitation.

Here, speech enhancement methods or speech enhancement model training methods in the embodiments of the present disclosure may be performed by an electronic device. The electronic device may be the terminal device 110 or the server 120. To be specific, the speech enhancement method may be performed by the terminal device 110 or the server 120, and the speech enhancement model training method may be performed by the terminal device 110 or the server 120, too.

In some embodiments, in a real-time communication scenario, an example in which the terminal device 120 performs both a speech enhancement method and a speech enhancement model training method is used for description.

The server 120 trains an initial speech enhancement model by using the speech enhancement model training method in this embodiment of the present disclosure, to obtain a trained speech enhancement model. In a process that a user A uses a terminal device 110 to perform real-time communication with a terminal device 110 of a user B, after the terminal device 110 of the user A transmits a speech signal of the user A to the terminal device 110 of the user B through the server 120. The terminal device 110 of the user B may process the received speech signal by using the speech enhancement method of this embodiment of the present disclosure and the trained speech enhancement model, to obtain estimated gain information, then perform speech enhancement on the speech signal based on the estimated gain information, namely, denoise the speech signal to obtain an enhanced speech signal, and play the enhanced speech signal.

Here, FIG. 1 is merely an example for description. A quantity of terminal devices and a quantity of servers are actually not limited, and are not specifically limited in this embodiment of the present disclosure.

A speech enhancement method and a speech enhancement model training method that are provided in exemplary implementations of the present disclosure will be described below with reference to the accompanying drawings in conjunction with the application scenario described above. The application scenario is merely shown for ease of understanding the spirit and principle of the present disclosure, and the implementations of the present disclosure are not limited in this aspect.

In this embodiment of the present disclosure, an initial speech enhancement model is trained to obtain a trained speech enhancement model. As shown in FIG. 2, the initial speech enhancement model includes an input layer 201, a frequency band compression layer 202, a feature mapping layer 203, and an output layer 204. A training process of the speech enhancement model is described in the following embodiments.

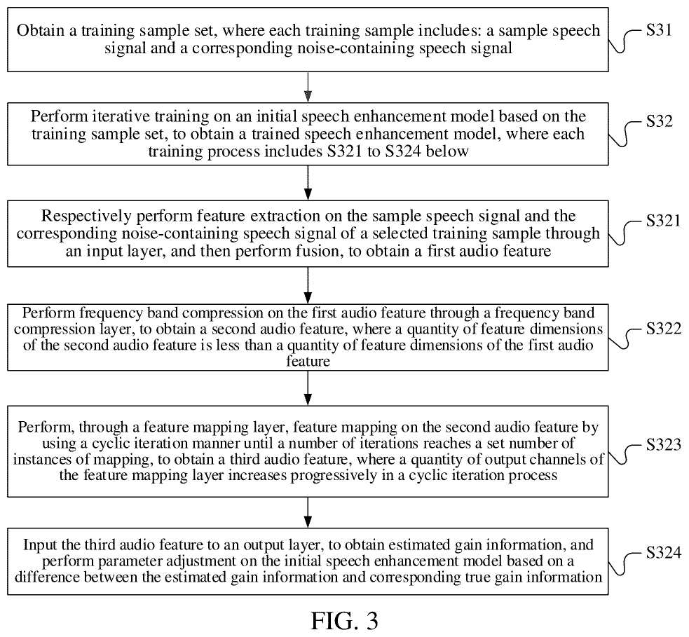

FIG. 3 shows a flowchart of a speech enhancement model training method according to an embodiment of the present disclosure. An example in which a server performs the method is used. The method specifically includes the following operations S31 to S32:

S31: Obtain a training sample set, each training sample including: a sample speech signal and a corresponding noise-containing speech signal.

The sample speech signal and the noise-containing speech signal of each training sample are both frequency domain signals. In a possible implementation, the sample speech signal is obtained by transforming an original sample speech signal from a time domain into a frequency domain, and the noise-containing speech signal is obtained by transforming an original noise-containing speech signal from the time domain into the frequency domain.

The sample speech signal may be acquired on site. To improve model training quality, an acquisition environment needs to reduce occurrence of noise as much as possible, such as background noise. However, the present disclosure does not limit that the sample speech signal itself completely does not carry noise. For example, the sample speech signal may carry some unavoidable noises.

The noise-containing speech signal is obtained by adding noise based on the sample speech signal. In a possible implementation, the original noise-containing speech signal is obtained by adding noise to the corresponding original sample speech signal. The added noise may be common noise in a true environment.

In some embodiments, the original sample speech signal and the original noise-containing speech signal may be ultra wide band speech signals (having a sampling rate of 32000 Hz and a bandwidth of 16000 Hz), or certainly, may be ordinary wide band speech signals. This is not limited.

Specifically, the original sample speech signal may be transformed from a time domain into a frequency domain by using discrete Fourier transform. The discrete Fourier transform includes fast Fourier transform (FFT), or the like. For example, FFT is performed on the original sample speech signal to obtain eigenvalues of a plurality of frequency points. Each eigenvalue includes a real part and an imaginary part of an amplitude. The real part represents an amplitude of the speech signal, and the imaginary part represents a phase change of the speech signal along with a frequency change.

In addition, each training sample further includes true gain information. The true gain information may be obtained by calculation based on the sample speech signal and the noise-containing speech signal of the training sample. Specifically, the true gain information may be obtained by dividing an energy spectrum of the sample speech signal by a sum of an energy spectrum of the sample speech signal and an energy spectrum of the noise-containing speech signal. The true gain information may accurately identify the noise added to the noise-containing speech signal.

S32: Perform iterative training on an initial speech enhancement model based on the training sample set, to obtain a trained speech enhancement model. Each training process includes S321 to S324.

S321: Respectively perform feature extraction on the sample speech signal and the corresponding noise-containing speech signal of a selected training sample through an input layer, and then perform fusion, to obtain a first audio feature.

In this embodiment of the present disclosure, the input layer of the initial speech enhancement model may use a neural network, for example, a convolutional neural network. The feature extraction is respectively performed on the sample speech signal and the noise-containing speech signal through the convolutional neural network, and then the fusion is performed, to obtain the first audio feature. It is assumed that each of the sample speech signal and the noise-containing speech signal includes eigenvalues of 513 frequency points. After the feature extraction is performed through the input layer, a feature dimension of the obtained first audio feature may be 513.

The sample speech signal and the corresponding noise-containing speech signal that are fused to obtain the first audio feature may be referred to as a speech signal pair. It is assumed that a speech signal pair 1 includes a sample speech signal 1 and a noise-containing speech signal 1, the noise-containing speech signal 1 is obtained by adding noise to the sample speech signal 1.

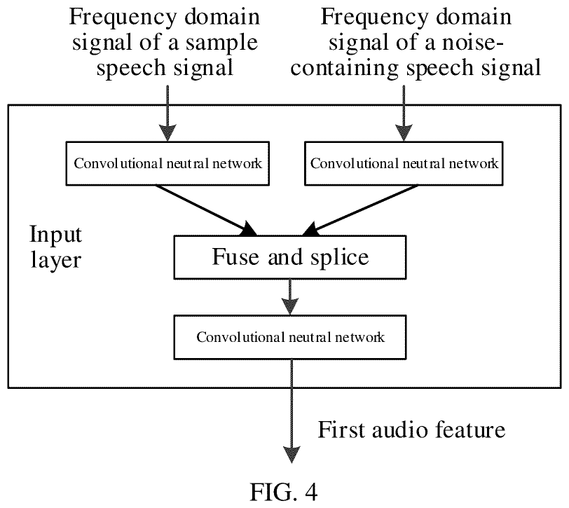

In some implementations, as shown in FIG. 4, the input layer includes two convolutional neural networks that are in parallel and one convolutional neural network connected to the two convolutional neural networks. The sample speech signal and the noise-containing speech signal are respectively inputted to the two convolutional neural networks that are in parallel. Output features of the two convolutional neural networks are spliced and then inputted to the other convolutional neural network for feature integration, to obtain the first audio feature.

S322: Perform frequency band compression on the first audio feature through a frequency band compression layer, to obtain a second audio feature. A quantity of feature dimensions of the second audio feature is less than a quantity of feature dimensions of the first audio feature.

The frequency band compression layer may divide frequencies of the first audio feature into a set quantity of frequency bands. For example, the frequency band compression layer may include a band-pass filter. The frequencies of the first audio feature may be converted into a set quantity of frequency bands by converting the frequencies into acoustic perceptual scales, to obtain a second audio feature including the set quantity of frequency bands. It is assumed that the first audio feature includes 513 dimensions, namely, eigenvalues of 513 frequency points. The second audio feature is obtained after the 513 frequency points are converted into the set quantity of frequency bands, including the eigenvalues of the set quantity of frequency bands. The eigenvalue of each frequency band includes an amplitude. The set quantity is less than 513, for example, 128, and the second audio feature includes 128 dimensions. Therefore, dimensionality reduction may be performed on the first audio feature through the frequency band compression layer, to obtain a dimensionality-reduced second audio feature.

In some embodiments, S32 of performing frequency band compression on the first audio feature to obtain a second audio feature may include the following operations A1 to A2:

A1: Transform the first audio feature from a frequency domain into an acoustic perceptual scale domain, and divide a transformed first audio feature into a set quantity of audio sub-features based on the acoustic perceptual scale domain.

An acoustic perception scale may be an ERB scale, a Mel scale, or a Bark scale. Specifically, a lowest frequency and cut-off frequency of the first audio feature are transformed into acoustic perceptual scales based on a nonlinear function. For example, an example in which the acoustical perceptual scale is the ERB scale is used. The lowest frequency and the cut-off frequency are transformed into the acoustical perceptual scales based on a nonlinear function shown in the following formula (1), to obtain a lowest ERB scale and a highest ERB scale:

$$\{ \begin{matrix}E R B = A {log}_{10} ( 1 + hz ( 0.00437 ) ) \\ A = \frac{1000 {log}_{e} ( 10 )}{24.7 \times 4.37}\end{matrix} \qquad ( 1 )$$

It is assumed that the set quantity is M. Scales from the lowest ERB scale to the highest ERB scale are divided into M equal parts, to obtain audio sub-features corresponding to the M scale segments. For example, if the lowest ERB scale is 0, and the highest ERB scale is 40, scales from 0 to 40 are divided into M equal scale segments.

A2: Respectively inversely transform the set quantity of audio sub-features from the acoustic perceptual scale domain into the frequency domain, and respectively filter, through a band-pass filter, inversely transformed audio sub-features of frequency bands, to obtain a second audio feature including the set quantity of frequency bands.

The scale segment of each audio sub-feature is inversely transformed from an acoustic perceptual scale into a frequency. The inverse transformation process is an inverse process of the transformation process in operation A1. For example, the ERB scale is still used as an example. The inverse transformation process is an inverse process of formula (1). Each scale segment is inversely transformed into a frequency band, to obtain the second audio feature including the set quantity of frequency bands, which is specifically in the form of a feature vector.

In this embodiment of the present disclosure, the first audio feature is transformed from the frequency domain into the acoustic perceptual scale domain, so that the frequencies of the first audio feature may be divided into the set quantity of frequency bands in the acoustic perceptual scale domain, to obtain the second audio feature, thereby implementing feature dimensionality reduction. In subsequent operations, operation complexity can be reduced, and an operation speed can be improved.

S323: Perform, through the feature mapping layer, feature mapping on the second audio feature by using a cyclic iteration manner until a number of iterations reaches a set number of instances of mapping, to obtain a third audio feature. A quantity of output channels of the feature mapping layer progressively increases in a cyclic iteration process.

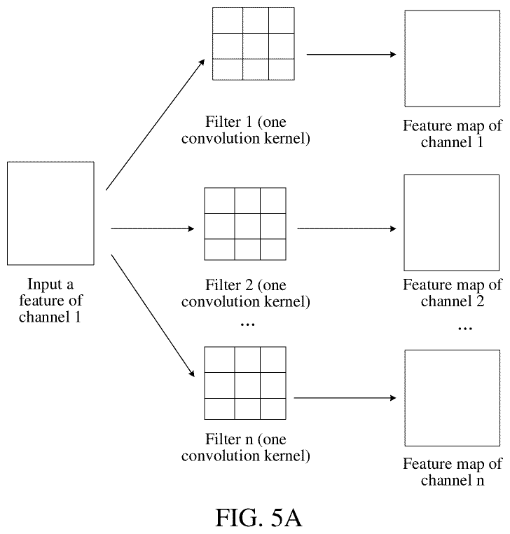

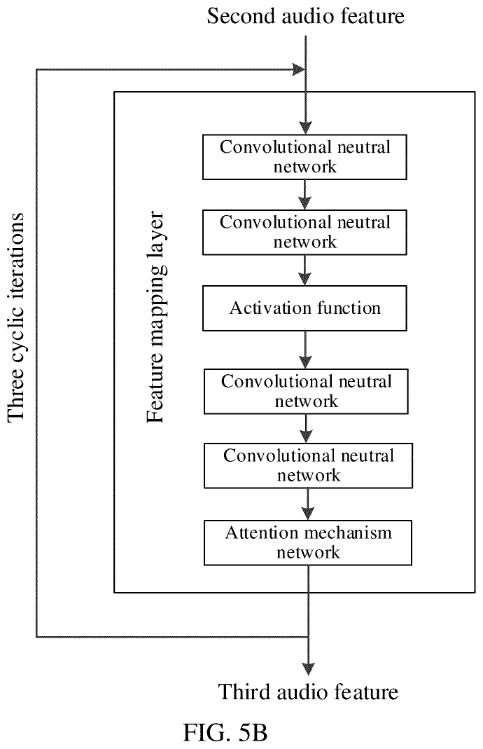

The set number of instances of mapping may be set as required. For example, the preset number may be set to 3. This is not limited. In each iteration, the quantity of output channels of the feature mapping layer may alternatively be set as required. This may be specifically implemented by setting a network structure of the feature mapping layer. For example, the feature mapping layer includes a convolutional neural network, and the quantity of output channels of the feature mapping layer may be determined according to a quantity of filters of a convolutional layer. The filters may be considered as a set of convolution kernels. To be specific, each filter may include one or more convolution kernels. Each filter may output a feature map, and a quantity of feature maps is the quantity of output channels. For example, as shown in FIG. 5A, it is assumed that a feature of a channel 1 is inputted. The input feature is convolved respectively by n filters (each including one convolution kernel), and each filter outputs a feature map of one channel, thereby obtaining feature maps of n channels. To be specific, the quantity of output channels is n. In a plurality of cyclic iterations, the quantity of filters used in each iteration may progressively increase, so that the quantity of output channels progressively increases.

In some embodiments, in the cyclic iteration process, the quantity of output channels of the feature mapping layer may progressively increase exponentially. For example, three iterations are taken as an example. Quantities of output channels are 32, 64, and 128 in sequence. This is not limited.

In this embodiment of the present disclosure, cyclic iteration is performed on the input second audio feature through the feature mapping layer, and the quantity of output channels progressively increases, so that a depth of feature mapping and a parameter amount can be increased without adding a model structure, and features of an input signal can be learned more effectively, to ensure a processing effect on a trained model.

In some embodiments, the feature mapping layer may include at least one layer of convolutional neural network and an attention mechanism network. S33 in the above embodiment may include the following operations B1 to B2:

The following operations are performed by cyclic iteration until the number of iterations reaches the set number of instances of mapping:

B1: Input the second audio feature to the at least one layer of convolutional neural network in sequence for convolving, to obtain an intermediate convolutional feature, and input the intermediate convolutional feature to the attention mechanism network for feature interaction, to obtain a new second audio feature.

A quantity of layers of convolutional neural networks of the feature mapping layer may be set according to a requirement. The feature mapping layer may further include an activation function, for example, a PReLU function, a ReLU function, a tanh function, or a sigmoid function. The activation function may be located between the at least one layer of convolutional neural network, or may be located between the at least one layer of convolutional neural network and the attention mechanism network. After the second audio feature is inputted to the at least one layer of convolutional neural network in sequence, convolutional features of a plurality of channels (e.g., the intermediate convolutional feature) are obtained. Then, for the convolutional feature of each channel, different weights are given to different parts of the convolutional feature based on the attention mechanism network, so as to pay attention to important information more precisely, thereby obtaining new convolutional features of the plurality of channels as the new second audio feature.

B2: Use the new second audio feature as the third audio feature.

In some implementations, as shown in FIG. 5B, the feature mapping layer includes two convolutional neural networks that are connected to each other, an activation function, a convolutional neural network, and an attention mechanism network. If the set number of instances of mapping is three, the second audio feature is inputted to the two convolutional neural networks, the activation function, the convolutional neural network, and the attention mechanism network in sequence, and an output result of the attention mechanism network is inputted to the foregoing several networks again. The rest can be deduced by analogy, until the third audio feature is outputted after three cyclic iterations. The third audio feature is in the form of a feature vector, and specifically includes eigenvalues of the set quantity of frequency bands.

In this embodiment of the present disclosure, the feature mapping layer first convolves the input second audio feature, and then performs feature interaction on the convolutional feature through the attention mechanism network, so that more attention can be paid to important information in the convolutional feature, thereby improving processing performance and processing efficiency of the speech enhancement model.

S324: Input the third audio feature to an output layer, to obtain estimated gain information, and perform parameter adjustment on the initial speech enhancement model based on a difference between the estimated gain information and corresponding true gain information.

The output layer may include a neural network which may be, for example, a convolutional neural network. The third audio feature outputted by the feature mapping layer is inputted to the convolutional neural network to obtain the estimated gain information. The estimated gain information includes estimated gains of the set quantity of frequency bands, and a quantity of dimensions of the estimated gain information is consistent with the quantity of feature dimensions of the second audio feature outputted by the frequency band compression layer, for example, 128 dimensions. Before the difference between the estimated gain information and the true gain information is determined, frequency band decompression which is an inverse process of the frequency band compression in S32 may be performed on the estimated gain information, so that dimensionality elevation is performed on the estimated gain information to cause a quantity of dimensions of the estimated gain information to be consistent with the quantity (e.g. 513) of feature dimensions of the input noise-containing speech signal. Then, a difference between dimensionality-elevated estimated gain information and the true gain information is determined, and the parameter adjustment is performed on the initial speech enhancement model.

Since the estimated gain information can reflect noise recognized by the initial speech enhancement model based on two types of input speech signals, and the true gain information accurately identifies the noise actually added to the sample speech signal, a noise recognition error of the initial speech enhancement model can be accurately identified based on the difference, thus guiding adjustment of a model parameter.

In some embodiments, S324 of performing parameter adjustment on the initial speech enhancement model based on a difference between the estimated gain information and corresponding true gain information may include the following operations C1 to C2:

C1: Perform frequency band decompression on the estimated gains of the set quantity of frequency bands, to obtain decompressed estimated gain information, the decompressed estimated gain information including estimated gains of frequencies of the noise-containing speech signal.

The frequency band decompression may be understood as an inverse process of the frequency band compression in S322 in the above embodiment of the present disclosure. In some embodiments, the set quantity of frequency bands are respectively transformed from the frequency domain into the acoustic perceptual scale domain to obtain acoustic perceptual scale ranges within a set quantity range, and the acoustic perceptual scale ranges within the set quantity range are combined into one acoustic perceptual scale range and then the acoustic perceptual scale range is inversely transformed into the frequency domain to obtain the estimated gains of the frequencies.

C2: Perform the parameter adjustment on the initial speech enhancement model based on a difference between the decompressed estimated gain information and the corresponding true gain information.

In this embodiment of the present disclosure, a loss value between the estimated gain information and the true gain information may be calculated based on a loss function. For example, the loss function may be a mean-square error (MSE) loss function. Backpropagation is performed on the loss value. To be specific, gradients of parameters of the network layers of the initial speech enhancement model are inversely obtained based on the parameters of the network layers, and then the parameters of the network layers of the initial speech enhancement model may be updated by using a gradient descent manner. For example, the parameters of the network layers of the initial speech enhancement model may include a convolution kernel parameter (such as a weight), a bias parameter, and the like, and may further include an activation function parameter or the like.

When the gain information (the estimated gain information and the true gain information) is represented in a frequency domain dimension (the set quantity of frequency bands), the decompressed estimated gain information may be obtained through the frequency band decompression, and the difference between the decompressed estimated gain information and the true gain information in the frequency domain dimension may be determined based on the decompressed estimated gain information and the true gain information. Since the frequency domain dimension is more suitable for expressing a speech signal, the difference between the two pieces of gain information may be identified more intuitively and accurately, to help the initial speech enhancement model learn recognition knowledge of noise in the frequency domain dimension, thereby improving model training quality.

In the embodiments of the present disclosure, feature dimensionality reduction is performed through the frequency band compression layer in each round of training of the initial speech enhancement model, thereby greatly reducing subsequent operation complexity. In addition, due to the cyclic iteration of the feature mapping layer, a depth of feature mapping and a parameter amount can be increased without adding a model structure, so that a model training effect is enhanced, and the trained speech enhancement model ensures a processing effect and reduces the operation complexity to improve an operation speed, thereby meeting a real-time operation requirement and enhancing a communication experience.

In some embodiments, the output layer in S324 may include an intermediate convolutional network and an output convolutional network, and then S324 of obtaining estimated gain information based on the third audio feature through the output layer of the initial speech enhancement model may specifically include the following operations D1-D2:

D1: Convolve, through the intermediate convolutional network, the third audio feature by using the cyclic iteration manner until the number of iterations reaches a set number of instances of convolving, to obtain an intermediate audio feature. A quantity of output channels of the intermediate convolutional network remains unchanged in the cyclic iteration process.

The intermediate convolutional network may include at least one layer of convolutional neural network. A quantity of layers may be set according to a requirement, and the set number of instances of convolving may be set according to a requirement. For example, the intermediate convolutional network includes two layers of convolutional neural networks, and the set number of instances of convolving is two. This is not limited.

The quantity of output channels of the intermediate convolutional network may be set according to a requirement. For example, the quantity of output channels of the intermediate convolutional network may be consistent with the quantity of output channels of the feature mapping layer in a last iteration, which is 128 for example. This is not limited.

D2: Convolve, through the output convolutional network, the intermediate audio feature by using the cyclic iteration manner until the number of iterations reaches a set number of instances of outputting, to obtain the estimated gain information. A quantity of output channels of the output convolutional network progressively decreases in the cyclic iteration process.

The output convolutional network may include at least one layer of convolutional neural network. A quantity of layers may be set according to a requirement, and the set number of instances of outputting may be set according to a requirement. For example, the output convolutional network includes three layers of convolutional neural networks, and the set number of instances of outputting is three. This is not limited.

Quantities of output channels of the output convolutional network in a plurality of iterations may be set according to a requirement. For example, the quantities of output channels in the plurality of iterations may progressively decrease exponentially. If three cyclic iterations are performed on the feature mapping layer, and the quantities of output channels are respectively 32, 64, and 128, three cyclic iterations are also performed on the output convolutional network, and the quantities of output channels are respectively 128, 64, and 32. This is not limited.

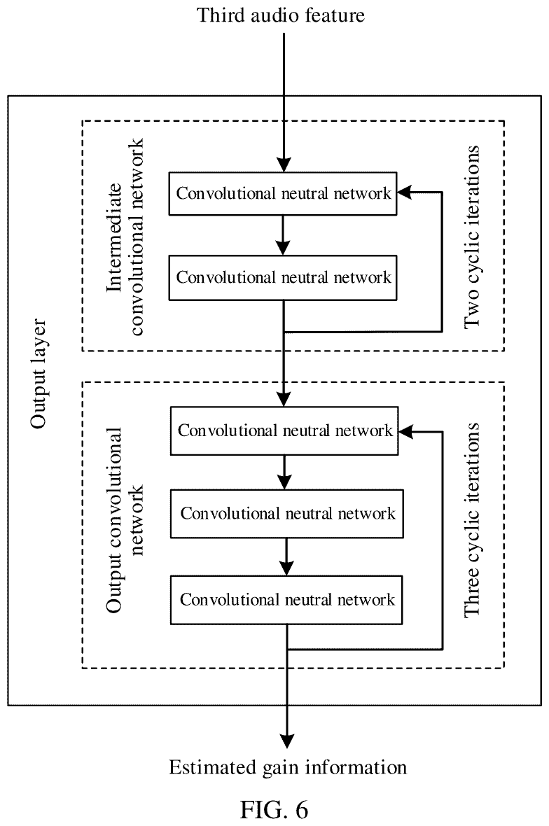

In some implementations, as shown in FIG. 6, the intermediate convolutional network in the output layer includes two layers of convolutional neural networks that are connected, and the output convolutional network includes three layers of convolutional neural networks that are connected in sequence. It is assumed that a number of iterations of the intermediate convolutional network is two and a number of iterations of the output convolutional network is three. The third audio feature outputted by the feature mapping layer is inputted to the two layers of convolutional neural networks of the intermediate convolutional network in sequence, and two cyclic iterations are performed to output the intermediate audio feature. Then, the intermediate audio feature is inputted to the three layers of convolutional neural networks of the output convolutional network in sequence, and three cyclic iterations are performed, thereby outputting the estimated gain information.

In this embodiment of the present disclosure, the cyclic iteration and convolving are performed on the output of the feature mapping layer through the intermediate convolutional network, to further enhance a feature extraction effect. Then, cyclic iteration and convolving are performed on the output of the intermediate convolutional network through the output convolutional network, to progressively reduce the quantity of output channels, thereby outputting a final estimated gain information.

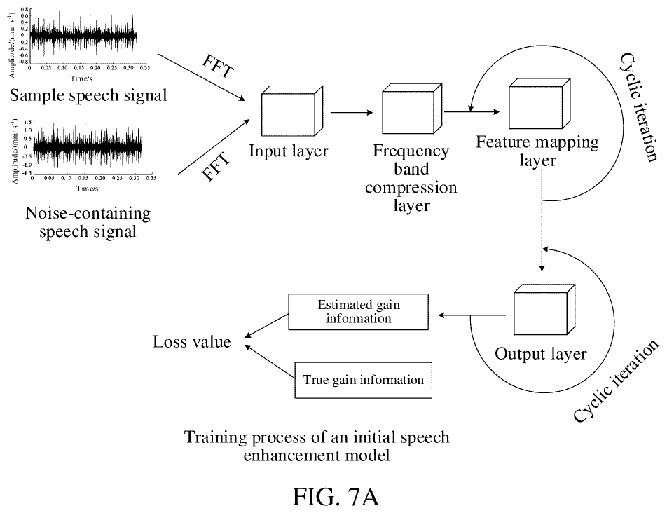

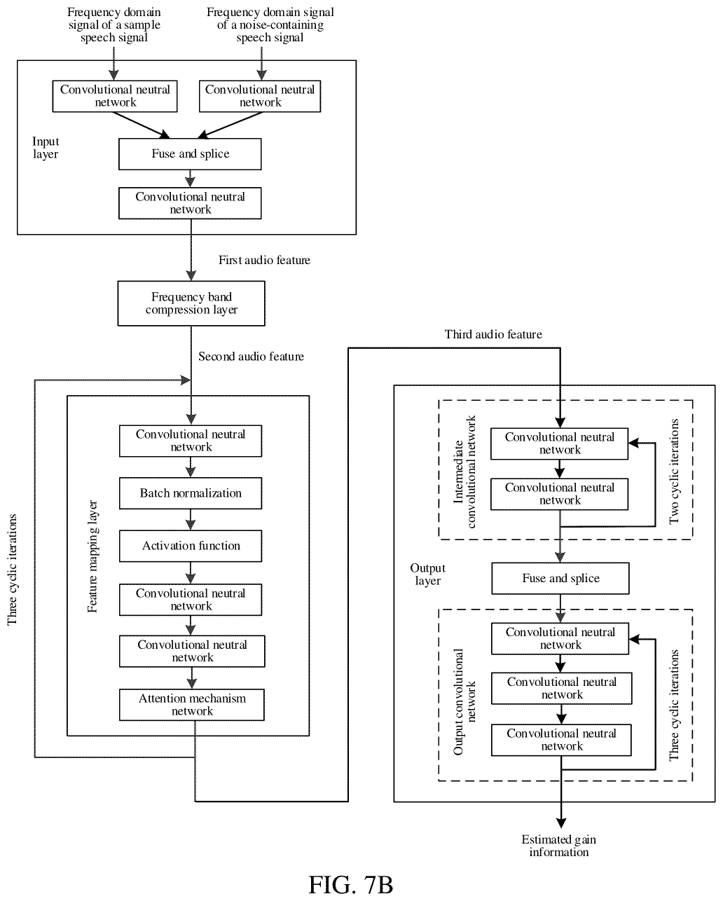

A training process of an initial speech enhancement model according to an embodiment of the present disclosure will be exemplarily described below with reference to FIG. 7A and FIG. 7B.

In this embodiment of the present disclosure, a training sample inputted to the initial speech enhancement model includes a pair of sample speech signal and noise-containing speech signal. As shown in FIG. 7A, before the training sample is inputted to the initial speech enhancement model, FFT is first performed on the sample speech signal and the noise-containing speech signal respectively. For example, the sample speech signal and the noise-containing speech signal are respectively transformed by using an FFT operation with 1024 sampling points, to respectively obtain frequency domain signals of the two signals. Each frequency domain signal includes amplitudes at frequencies. Each amplitude includes a real part and an imaginary part. The real part includes 513 features, and the imaginary part also includes 513 features. Therefore, there are 513*4 eigenvalues in total.

Then, the frequency domain signals of the sample speech signal and the noise-containing speech signal are inputted to an input layer and a frequency band compression layer of the initial speech enhancement model in sequence. An output of the frequency band compression layer is inputted to a feature mapping layer by cyclic iteration. Furthermore, a quantity of output channels progressively increases, and a number of iterations is set according to a requirement. An output of the feature mapping layer is inputted to an output layer by cyclic iteration. The output layer includes an intermediate convolutional network and an output convolutional network. Cyclic iteration is performed on the two convolutional networks respectively, and numbers of iterations of the two convolutional networks are set according to a requirement. In addition, a quantity of output channels of the intermediate convolutional network keeps unchanged, and a quantity of output channels of the output convolutional network progressively increases. Finally, the output layer outputs estimated gain information, calculates a loss value between the estimated gain information and true gain information (calculated based on the sample speech signal and the noise-containing speech signal), and performs parameter adjustment on the initial speech enhancement model based on the loss value.

As an example, as shown in FIG. 7B, each training process of the initial speech enhancement model is as follows:

1. Obtain a selected training sample which includes a frequency domain signal of the sample speech signal and a frequency domain signal of the noise-containing speech signal. For example, the frequency domain signals include 513*2 eigenvalues.

2. Respectively input the frequency domain signals of both the sample speech signal and the noise-containing speech signal of the training sample to the two parallel convolutional neural networks of the input layer, fuse and splice outputs of the two convolutional neural networks, and then integrate feature data through one convolutional neural network, to obtain a first audio feature.

3. Input the first audio feature to the frequency band compression layer, for example, an ERB module. A function of the frequency band compression layer is to perform frequency band compression on the first audio feature, to further reduce the operation complexity.

For example, a dimension of the first audio feature is reduced from 513 to 128 (it is assumed that the frequency band compression layer includes 128 frequency bands), to obtain a second audio feature, thereby reducing the quantity of feature dimensions.

4. Input an output result of the frequency band compression layer to the feature mapping layer, and perform three cyclic iterations through a series of sub-networks: a convolutional neural network, batch normalization, an activation function, two convolutional neural networks, and one attention mechanism network. Quantities of output channels in the three cyclic iterations progressively increase in sequence.

A function of the batch normalization is to normalize an output of a first convolutional neural network, so as to solve a problem that a value in a deep neural network is unstable, so that training samples in the same batch have similar feature distributions and are trained more easily. The activation function may be a PRELU function, an ReLU function, a tanh function, a sigmoid function, or the like.

For example, the quantities of output channels of the feature mapping layer in the three cyclic iterations are respectively 32, 64, and 128, so that a network depth and a parameter amount are increased, and a signal feature can be learned more effectively.

5. Input a third audio feature outputted by the feature mapping layer after the three cyclic iterations to the intermediate convolutional network of the output layer. The intermediate convolutional network includes two convolutional neural networks. After two cyclic iterations are performed, quantities of output channels in the two cyclic iterations remain unchanged, and are respectively 128 and 128 for example.

6. Input an output result of the intermediate convolutional network after the two cyclic iterations to the output convolutional network of the output layer. The output convolutional network includes three layers of convolutional neural networks. After three cyclic iterations are performed, quantities of output channels in the three cyclic iterations progressively decrease.

For example, the quantities of output channels in the three cyclic iterations are respectively 128, 64, and 32, to reduce the quantity of channels of an output feature and keep the dimension of the output feature consistent with the dimension of the input feature of the feature mapping layer.

7. Finally, by the output layer, output the estimated gain information obtained by estimation, then calculate the loss value between the estimated gain information and the true gain information (calculated based on the sample speech signal and the noise-containing speech signal), and perform parameter adjustment on the initial speech enhancement model based on the loss value.

Specifically, the frequency band decompression may be performed on the estimated gain information, which is the inverse process of the frequency band compression of the frequency band compression layer in operation 3, to obtain the dimensionality-elevated estimated gain information. For example, the quantity of dimensions increases from 128 to 513. When the true gain information is calculated based on the sample speech signal and the noise-containing speech signal, an energy spectrum (obtained based on the frequency domain signal) of the sample speech signal may be divided by a sum of the energy spectrum of the sample speech signal and an energy spectrum of the noise-containing speech signal, to obtain the true gain information. Finally, the loss value between the estimated gain information and the true gain information may be calculated based on the MSE loss function.

After the training on the initial speech enhancement model is completed, a trained speech enhancement model is obtained. The speech enhancement model is configured for online enhancement. Only discrete Fourier transform (e.g. FFT) needs to be performed on the noise-containing speech signal to obtain a frequency domain feature, such as 513*2 real part and imaginary part features (which are consistent with the input features in the above training process). Then, the frequency domain feature is inputted to the trained speech enhancement model, and adaptive parameter adaptation may be performed on the model, thereby obtaining optimal estimated gain information. Finally, after the frequency band decompression is performed on the estimated gain information, the estimated gain information is multiplied by a power spectrum of the noise-containing speech signal, and a final enhanced speech signal may be obtained by using the inverse FFT.

An embodiment of the present disclosure further provides a speech enhancement method. This method is implemented by using the trained speech enhancement model in the above embodiment. The speech enhancement method will be described below.

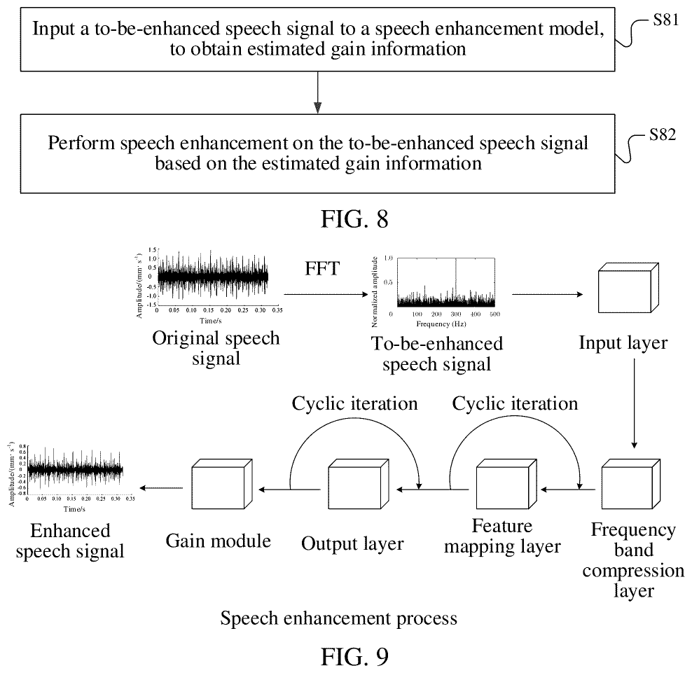

FIG. 8 is a flowchart of a speech enhancement method according to an embodiment of the present disclosure. An example in which a terminal device is an execution entity is used. A specific implementation flow of the method includes S81 to S82 below:

S81: Input a to-be-enhanced speech signal to a speech enhancement model, to obtain estimated gain information.

In a real-time communication process, an original speech signal received by the terminal device is a time-domain signal, a horizontal axis of which represents a time point and a vertical axis of which represents an amplitude. To facilitate feature analysis on the original speech signal, the original speech signal is transformed from a time domain into a frequency domain, to obtain the to-be-enhanced speech signal, a horizontal axis of which represents a frequency point and a vertical axis of which represents an amplitude. In some embodiments, the original speech signal may be an ultra wide band speech signal, or may be an ordinary wide band speech signal. This is not limited.

Specifically, the original speech signal may be transformed from the time domain into the frequency domain by using discrete Fourier transform. For example, FFT is performed on the original speech signal to obtain eigenvalues of a plurality of frequency points. Each eigenvalue includes a real part and an imaginary part of an amplitude. The real part represents an amplitude of the signal, and the imaginary part represents a phase change of the signal along with a frequency change.

It can be known based on the above embodiment of the present disclosure that the speech enhancement model includes an input layer, a frequency band compression layer, a feature mapping layer, and an output layer. The to-be-enhanced speech signal is inputted to the above network layers in sequence, to obtain the estimated gain information.

The specific implementation flow of S81 will be described below.

In some embodiments, the inputting a to-be-enhanced speech signal to a speech enhancement model, to obtain estimated gain information specifically includes the following operations E1 to E4:

E1: Extract a first audio feature of the to-be-enhanced speech signal through the input layer of the speech enhancement model.

The feature extraction is performed on the to-be-enhanced speech signal through the input layer of the speech enhancement model, and a feature dimension of the obtained first audio feature may be 513. To be specific, a quantity of feature dimensions of the first audio feature may be consistent with a quantity of feature dimensions of the to-be-enhanced speech signal.

E2: Perform frequency band compression on the first audio feature through the frequency band compression layer of the speech enhancement model, to obtain a second audio feature. A quantity of feature dimensions of the second audio feature is less than the quantity of feature dimensions of the first audio feature.

A specific implementation process of this operation is similar to the specific implementation process of S322 in the above embodiment of the present disclosure, and details thereof will not be elaborated herein again.

E3: Perform, through the feature mapping layer of the speech enhancement model, feature mapping on the second audio feature by using a cyclic iteration manner until a number of iterations reaches a set number of instances of mapping, to obtain a third audio feature. A quantity of output channels of the feature mapping layer progressively increases in a cyclic iteration process.

A specific implementation process of this operation is similar to the specific implementation process of S323 in the above embodiment of the present disclosure, and details thereof will not be elaborated herein again.

E4. Input the third audio feature to the output layer of the speech enhancement model, and obtain estimated gain information based on the third audio feature, the estimated gain information being configured for performing speech enhancement on the to-be-enhanced speech signal.

A specific implementation process of this operation is similar to the specific implementation process of S324 in the above embodiment of the present disclosure, and details thereof will not be elaborated herein again.

In this embodiment of the present disclosure, when the speech enhancement model is used for speech enhancement, the first audio feature of the to-be-enhanced speech signal is first extracted. Then, to reduce subsequent operation complexity, the frequency band compression is performed on the first audio feature, to obtain the dimensionality-reduced second audio feature. Further, through the feature mapping layer of the speech enhancement model, the feature mapping is performed on the second audio feature by using the cyclic iteration manner. Meanwhile, the quantity of output channels of the feature mapping layer progressively increases. In this way, a depth of feature mapping can be increased without adding a model structure, thereby ensuring a model processing effect. Finally, the estimated gain information is obtained based on the third audio feature outputted by the feature mapping layer, so as to perform speech enhancement on the to-be-enhanced speech signal. Therefore, this embodiment of the present disclosure can ensure a processing effect and reduce operation complexity to improve an operation speed, thereby meeting a real-time operation requirement and enhancing a communication experience.

S82: Perform speech enhancement on the to-be-enhanced speech signal based on the estimated gain information, to remove noise from the to-be-enhanced speech signal to obtain an enhanced speech signal.

The estimated gain information includes estimated gains of a set quantity of frequency bands. Before the speech enhancement is performed on the to-be-enhanced speech signal based on the estimated gain information, frequency band decompression may be performed on the estimated gain information to obtain the estimated gains of the frequencies of the to-be-enhanced speech signal, and then the speech enhancement is performed on the to-be-enhanced speech signal. The frequency band decompression may be understood as an inverse process of the frequency band compression in operation E2 of the present disclosure.

In this embodiment of the present disclosure, when the speech enhancement model is used for speech enhancement, the first audio feature of the to-be-enhanced speech signal is first extracted. Then, to reduce subsequent operation complexity, the frequency band compression is performed on the first audio feature, to obtain the dimensionality-reduced second audio feature. Further, through the feature mapping layer of the speech enhancement model, the feature mapping is performed on the second audio feature by using the cyclic iteration manner. Meanwhile, the quantity of output channels of the feature mapping layer progressively increases. In this way, a depth of feature mapping can be increased without adding a model structure, thereby ensuring a model processing effect. Finally, the estimated gain information is obtained based on the third audio feature outputted by the feature mapping layer, so as to perform speech enhancement on the to-be-enhanced speech signal. Therefore, this embodiment of the present disclosure can ensure a processing effect and reduce operation complexity to improve an operation speed, thereby meeting a real-time operation requirement and enhancing a communication experience.

In some embodiments, during the performing speech enhancement on the to-be-enhanced speech signal based on the estimated gain information in S82, the following operations F1 to F3 may be performed:

F1: Perform frequency band decompression on the estimated gains of the set quantity of frequency bands, to obtain estimated gains of frequencies of the to-be-enhanced speech signal.

This operation is an inverse process of the frequency band compression in operation E2. Specifically, the set quantity of frequency bands are respectively transformed from the frequency domain into the acoustic perceptual scale domain to obtain acoustic perceptual scale ranges within a set quantity range, and the acoustic perceptual scale ranges within the set quantity range are combined into one acoustic perceptual scale range and then the acoustic perceptual scale range is inversely transformed into the frequency domain to obtain the estimated gains of the frequencies.

F2: Obtain an initial enhanced speech signal based on the estimated gains of the frequencies and the to-be-enhanced speech signal.

Specifically, the estimated gains of the frequencies are multiplied by a power spectrum of the to-be-enhanced speech signal. The power spectrum includes power at the frequencies. To be specific, the estimated gain of each frequency is multiplied by the power at the frequency, to obtain the initial enhanced speech signal.

F3: Transform the initial enhanced speech signal from the frequency domain

into the time domain, to obtain a final enhanced speech signal.

The initial enhanced speech signal may be transformed from the frequency domain into the time domain by using the inverse discrete Fourier transform. For example, in the above embodiment of the present disclosure, FFT is performed on the original speech signal to obtain the to-be-enhanced speech signal. In operation F3, the initial enhanced speech signal is transformed from the frequency domain into the time domain by using inverse FFT, to obtain the final enhanced speech signal.

In this embodiment of the present disclosure, after the estimated gain information of the to-be-enhanced speech signal is obtained by using the speech enhancement model, the speech enhancement is performed on the to-be-enhanced speech signal based on the estimated gain information, to obtain the enhanced speech signal. The enhanced speech signal is a signal after noise in the original speech signal is removed, so that quality and intelligibility of a speech signal can be improved, thereby enhancing a communication experience.

An entire implementation flow of a speech enhancement method according to an embodiment of the present disclosure will be exemplarily described below with reference to FIG. 9.

As shown in FIG. 9, in a real-time communication process, after obtaining an original speech signal, a terminal device is configured to: first transform the original speech signal from a time domain into a frequency domain, for example, by FFT, to obtain a to-be-enhanced speech signal; then input the to-be-enhanced speech signal to an input layer and a frequency band compression layer of a speech enhancement model in sequence; input an output of the frequency band compression layer to a feature mapping layer by cyclic iteration, where a quantity of output channels progressively increases, and a number of iterations is set according to a requirement; input an output of the feature mapping layer to an output layer by cyclic iteration, where the output layer includes an intermediate convolutional network and an output convolutional network; cyclic iteration is performed on the two convolutional networks respectively, and numbers of iterations of the two convolutional networks are set according to a requirement; in addition, a quantity of output channels of the intermediate convolutional network keeps unchanged, and a quantity of output channels of the output convolutional network progressively increases; finally, the output layer outputs estimated gain information; and perform speech enhancement on the to-be-enhanced speech signal based on the estimated gain information through a gain module, to obtain an enhanced speech signal.

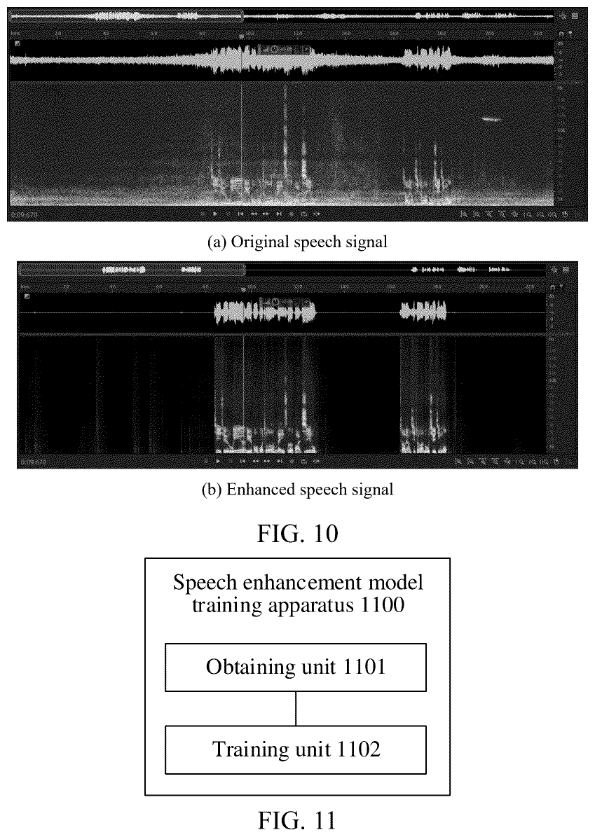

Exemplarily, an original speech signal is shown in FIG. 10(a). After the original speech signal is processed by using the speech enhancement flow of the embodiments of the present disclosure, an obtained enhanced speech signal obtained is shown in FIG. 10(b). As can be seen, a noise signal in the original speech signal is removed from the enhanced speech signal.

The speech enhancement method in this embodiment of the present disclosure may be applied to a real-time communication scenario, for example, a real-time conference scenario. When a call environment is noisy, background environment noise can be effectively removed by using the speech enhancement method in this embodiment of the present disclosure, thereby ensuring quality and intelligibility of a voice call.

For example, in a real-time communication process, after a microphone of the terminal device is turned on, a speech signal is acquired by the microphone, and then the terminal device performs speech enhancement on the speech signal by using the speech enhancement method in this embodiment of the present disclosure, to obtain a pure speech signal, namely, an enhanced speech signal, thus effectively reserving the voice of a main speaker and removing redundant background noise.

Based on the same inventive concept as the method embodiments, an embodiment of the present disclosure further provides a speech enhancement model training apparatus. A principle of the apparatus for solving a problem is similar to that of the speech enhancement model training method in the above embodiments. Therefore, for implementation of the apparatus, refer to the implementation of the above method, and repeated parts will not be elaborated herein again.

FIG. 11 is a structural block diagram of a speech enhancement model training apparatus according to an embodiment of the present disclosure. The apparatus 1100 includes:

an obtaining unit 1101, configured to obtain a training sample set, each training sample including: a sample speech signal and a corresponding noise-containing speech signal, the noise-containing speech signal being obtained by adding noise based on the sample speech signal; and

a training unit 1102, configured to perform iterative training on an initial speech enhancement model based on the training sample set, to obtain a trained speech enhancement model, the initial speech enhancement model including an input layer, a frequency band compression layer, a feature mapping layer, and an output layer, each training process including:

respectively performing feature extraction on the sample speech signal and the corresponding noise-containing speech signal of a selected training sample through the input layer, and then performing fusion, to obtain a first audio feature;

performing frequency band compression on the first audio feature through the frequency band compression layer, to obtain a second audio feature, a quantity of feature dimensions of the second audio feature being less than a quantity of feature dimensions of the first audio feature;

performing, through the feature mapping layer, feature mapping on the second audio feature by using a cyclic iteration manner until a number of iterations reaches a set number of instances of mapping, to obtain a third audio feature, a quantity of output channels of the feature mapping layer progressively increasing in a cyclic iteration process; and

inputting the third audio feature to the output layer, to obtain estimated gain information, and performing parameter adjustment on the initial speech enhancement model based on a difference between the estimated gain information and corresponding true gain information.

In the embodiments of the present disclosure, feature dimensionality reduction is performed through the frequency band compression layer in each round of training of the initial speech enhancement model, thereby greatly reducing subsequent operation complexity. In addition, due to the cyclic iteration of the feature mapping layer, a depth of feature mapping and a parameter amount can be increased without adding a model structure, so that a model training effect is enhanced, and the trained speech enhancement model ensures a processing effect and reduces the operation complexity to improve an operation speed, thereby meeting a real-time operation requirement and enhancing a communication experience.

In some embodiments, the output layer includes an intermediate convolutional network and an output convolutional network; and

when inputting the third audio feature to the output layer, to obtain the estimated gain information, the training unit 1102 is specifically configured to:

convolve, through the intermediate convolutional network, the third audio feature by using the cyclic iteration manner until the number of iterations reaches a set number of instances of convolving, to obtain an intermediate audio feature, where a quantity of output channels of the intermediate convolutional network remains unchanged in the cyclic iteration process; and

convolve, through the output convolutional network, the intermediate audio feature by using the cyclic iteration manner until the number of iterations reaches a set number of instances of outputting, to obtain the estimated gain information, where a quantity of output channels of the output convolutional network progressively decreases in the cyclic iteration process.

In some embodiments, the feature mapping layer includes at least one layer of convolutional neural network and an attention mechanism network; and

when performing, through the feature mapping layer, feature mapping on the second audio feature by using the cyclic iteration manner until the number of iterations reaches the set number of instances of mapping, to obtain the third audio feature, the training unit 1102 is specifically configured to:

perform the following operations by cyclic iteration until the number of iterations reaches the set number of instances of mapping:

inputting the second audio feature to the at least one layer of convolutional neural network in sequence for convolving, to obtain an intermediate convolutional feature;

inputting the intermediate convolutional feature to the attention mechanism network for feature interaction, to obtain a new second audio feature; and

using the new second audio feature as the third audio feature.

In some embodiments, both the sample speech signal and the noise-containing speech signal are frequency domain signals, and the first audio feature is a frequency domain feature; and

when performing frequency band compression on the first audio feature, to obtain the second audio feature, the training unit 1102 is specifically configured to:

transform the first audio feature from a frequency domain into an acoustic perceptual scale domain, and divide a transformed first audio feature into a set quantity of audio sub-features based on the acoustic perceptual scale domain; and

respectively inversely transform the set quantity of audio sub-features from the acoustic perceptual scale domain into the frequency domain, and respectively filter, through a band-pass filter, inversely transformed audio sub-features of frequency bands, to obtain a second audio feature including the set quantity of frequency bands.

In some embodiments, the estimated gain information includes estimated gains of the set quantity of frequency bands; and

when performing parameter adjustment on the initial speech enhancement model based on a difference between the estimated gain information and corresponding true gain information, the training unit 1102 is specifically configured to:

perform frequency band decompression on the estimated gains of the set quantity of frequency bands, to obtain decompressed estimated gain information, the decompressed estimated gain information including estimated gains of frequencies of the noise-containing speech signal; and

perform the parameter adjustment on the initial speech enhancement model based on a difference between the decompressed estimated gain information and the corresponding true gain information.

Based on the same inventive concept as the method embodiments, an embodiment of the present disclosure further provides a speech enhancement apparatus. A principle of the apparatus for solving a problem is similar to that of the speech enhancement method in the above embodiments. Therefore, for implementation of the apparatus, refer to the implementation of the above method, and repeated parts will not be elaborated herein again.

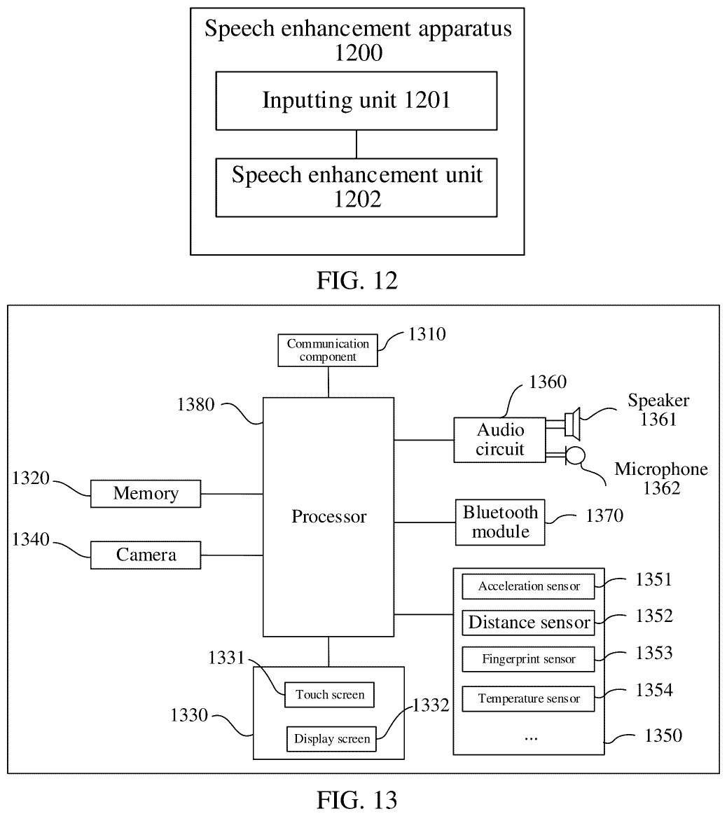

As shown in FIG. 12, an embodiment of the present disclosure provides a speech enhancement apparatus 1200, including:

an inputting unit 1201, configured to input a to-be-enhanced speech signal to a speech enhancement model, to obtain estimated gain information; and

a speech enhancement unit 1202, configured to perform speech enhancement on the to-be-enhanced speech signal based on the estimated gain information, to remove noise from the to-be-enhanced speech signal to obtain an enhanced speech signal.

In some embodiments, the to-be-enhanced speech signal is obtained after an original speech signal is transformed from a time domain into a frequency domain, and the estimated gain information includes estimated gains of a set quantity of frequency bands; and

the speech enhancement unit 1202 is specifically configured to:

perform frequency band decompression on the estimated gains of the set quantity of frequency bands, to obtain estimated gains of frequencies of the to-be-enhanced speech signal;

obtain an initial enhanced speech signal based on the estimated gains of the frequencies and the to-be-enhanced speech signal; and

transform the initial enhanced speech signal from the frequency domain into the time domain, to obtain a final enhanced speech signal.

For ease of description, the above components are respectively described as they are divided into units (or modules) based on functions. Certainly, during implementation of the present disclosure, the functions of the units (or modules) may be implemented in the same or a plurality of pieces of software or hardware.

After the speech enhancement method and apparatus according to the exemplary implementations of the present disclosure are described, an electronic device according to another exemplary implementation of the present disclosure is described next.

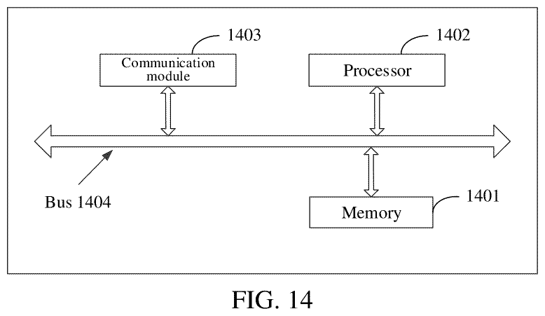

Based on a same inventive concept as the above method embodiments, an embodiment of the present disclosure further provides an electronic device. In an embodiment, the electronic device may be a terminal device, such as the terminal device 110 shown in FIG. 1. In this embodiment, a structure of the electronic device may be shown in FIG. 13, including: components such as a communication assembly 1310, a memory 1320, a display unit 1330, a camera 1340, a sensor 1350, an audio circuit 1360, a Bluetooth module 1370, and a processor 1380.

The communication module 1310 is configured to communicate with a server. In some embodiments, the structure of the electronic device may include a circuit wireless fidelity (WiFi) module. The WiFi module is a short distance wireless transmission technology, and the electronic device may help a user to transmit and receive information through the WiFi module.

The memory 1320 may be configured to store a software program and data. The processor 1380 executes various functions and data processing of the terminal device 110 by running the software program or data stored in the memory 1320.

The display unit 1330 may be further configured to display information entered by a user or information provided for a user, and a graphical user interface (GUI) of various menus of the terminal device 110.

The camera 1340 may be configured to capture a static image, and a user may issue the image captured by the camera 1340 through an application.

The terminal device may further include at least one sensor 1350.

The audio circuit 1360, a speaker 1361, and a microphone 1362 may provide audio interfaces between the user and the terminal device 110.

The Bluetooth module 1370 is configured to perform information interaction with other Bluetooth devices having Bluetooth modules through a Bluetooth protocol.

The processor 1380 is a control center of the terminal device, and is connected to parts of an entire terminal by using various interfaces and lines. By running or executing the software program stored in the memory 1320 and invoking data stored in the memory 1320, the processor performs various functions of the terminal device and processes data.

In another embodiment, the electronic device may alternatively be a server, for example, the server 120 shown in FIG. 1. In this embodiment, a structure of the electronic device may be shown in FIG. 14, including a memory 1401, a communication module 1403, and one or more processors 1402.

The memory 1401 is configured to store a computer program executed by the processor 1402. The memory 1401 may mainly include a program storage region and a data storage region, where the program storage region may store an operating system, a program required to run an instant messaging function, or the like. The data storage region may store various instant messaging information, an operation instruction set, and the like.

The memory 1401 may be a volatile memory, for example, a random access memory (RAM); the memory 1401 may alternatively be a non-volatile memory, for example, a read-only memory, a flash memory, a hard disk drive (HDD) or a solid-state drive (SSD); or the memory 1401 is any other medium capable of being configured to carry or store an expected computer program having an instruction or data structural form and being accessed by the computer. This is not limited herein. The memory 1401 may be a combination of the above memories.

The processor 1402 may include one or more central processing units (CPU), digital processing units, or the like. The processor 1402 is configured to implement the above speech enhancement method or the above speech enhancement model training method when calling the computer program stored in the memory 1401.

The communication module 1403 is configured to communicate with the terminal device or other servers.

Specific connecting media among the above memory 1401, communication module 1403 and processor 1402 are not limited in this embodiment of the present disclosure. In this embodiment of the present disclosure, in FIG. 14, the memory 1401 and the processor 1402 are connected by a bus 1404. The bus 1404 is described by a thick line in FIG. 14. Connecting modes for other components are schematically illustrated only, which are not limited herein. The bus 1404 may be classified as an address bus, a data bus, a control bus, or the like. For ease of description, only one thick line is used to describe the bus in FIG. 14, and it does not mean that there is only one bus or one type of buses.

The memory 1401 has a computer storage medium stored therein. The computer storage medium has a computer-executable instruction stored therein. The computer-executable instruction is configured for implementing the speech enhancement method or the speech enhancement model training method of the embodiments of the present disclosure. The processor 1402 is configured to perform the above speech enhancement method or the above speech enhancement model training method, as shown in FIG. 3 or FIG. 8.

In some possible implementations, the aspects of the speech enhancement method or the speech enhancement model training method provided in the present disclosure may be further implemented in the form of a program product including a computer program. When the program product is run on the electronic device, the computer program is configured to cause the electronic device to perform the operations of the speech enhancement method or the speech enhancement model training method according to the various exemplary implementations of the present disclosure described above in this specification. For example, the electronic device may perform the operations shown in FIG. 3 or FIG. 8.

The program product may use any combination of one or more readable media. The readable medium may be a readable signal medium or a readable storage medium. The readable storage medium may be, for example, but is not limited to, an electric, magnetic, optical, electromagnetic, infrared, or semiconductor system, apparatus, or device, or any combination thereof. More specific examples of the readable storage medium (nonexhaustive list) include: an electrical connection having one or more wires, a portable disk, a hard disk, a random access memory (RAM), a read only memory (ROM), an erasable programmable ROM (EPROM or a flash memory), an optical fiber, a compact disc ROM (CD-ROM), an optical storage device, a magnetic storage device, or any suitable combination thereof.

The program product in this implementation of the present disclosure may use a portable compact disc read-only memory (CD-ROM), includes a computer program, and may be run on the electronic device. However, the program product of the present disclosure is not limited thereto. In this specification, the readable storage medium may be any tangible medium that includes or stores a program. The program may be used by or in combination with a command execution system, apparatus, or device.

The readable signal medium may include a data signal propagated in a baseband or as a part of a carrier wave, which carries a computer-readable program. This propagated data signal may use a plurality of forms, including, but not limited to, an electromagnetic signal, an optical signal, or any suitable combination thereof. The readable signal medium may alternatively be any readable medium other than a readable storage medium, and the readable medium may be configured for sending, propagating, or transmitting a program used by or in combination with a command execution system, apparatus, or device.

The computer program included in the readable medium may be transmitted by using any suitable medium, including but not limited to a wireless medium, a wired medium, an optical cable, a radio frequency (RF), or the like, or any suitable combination thereof.

The computer program for performing the operations of the present disclosure may be written in one or a combination of more programming languages. The programming languages include an object-oriented programming language such as Java and C++, and conventional procedural programming languages such as “C” language or similar programming languages. The computer program may be executed entirely on a user electronic device, may be executed partially on a user electronic device, may be executed as an independent software package, may be executed partially on a user electronic device and partially on a remote electronic device, or may be executed entirely on a remote electronic device or a server. In a case involving the remote electronic device, the remote electronic device may be connected to the user electronic device through any type of network including a local region network (LAN) or a wide region network (WAN), or may be connected to an external electronic device (for example, connected through the Internet by using an Internet service provider).

Although a plurality of units or subunits of the apparatus are mentioned in the foregoing detailed descriptions, such division is merely exemplary and not mandatory. In fact, according to the implementations of the present disclosure, the features and functions of two or more units described above may be embodied in one unit. On the contrary, the features and functions of one unit described above may be embodied in a plurality of units.

In addition, although the operations of the methods of the present disclosure are described in a particular order in the accompanying drawings, this does not require or imply that these operations need to be performed in this particular order, or that all the shown operations need to be performed to achieve desired results. Additionally or alternatively, some operations may be omitted, a plurality of operations may be combined into one operation for execution, and/or one operation may be decomposed into a plurality of operations for execution.

A person skilled in the art can understand that the embodiments of the present disclosure may be provided as a method, a system, or a computer program product. Therefore, the present disclosure may use a form of hardware-only embodiments, software-only embodiments, or embodiments combining software and hardware. Moreover, the present disclosure may use the form of a computer program product implemented on one or more computer-available storage media (including, but not limited to, a magnetic disk memory, a CD-ROM, an optical memory, and the like) including a computer-available program.

The present disclosure is described with reference to the flowcharts and/or the block diagrams of the method, the device (system), and the computer program product according to the embodiments of the present disclosure. Computer program instructions can be configured for implementing each flow and/or each block in the flowcharts and/or the block diagrams and a combination of a flow and/or a block in the flowcharts and/or the block diagrams. These computer program instructions may be provided to a general-purpose computer, a special-purpose computer, an embedded processor, or a processor of another programmable data processing device to generate a machine, so that an apparatus for implementing functions specified in one or more flows in the flowcharts and/or one or more blocks in the block diagrams is generated by using instructions executed by a computer or the processor of the another programmable data processing device.

These computer program instructions may alternatively be stored in a computer-readable memory that may instruct a computer or the another programmable data processing device to work in a particular manner, so that the instructions stored in the computer-readable memory generate a product that includes an instruction apparatus. The instruction apparatus implements a specified function in one or more flows in the flowcharts and/or in one or more blocks in the block diagrams.

These computer program instructions may be further loaded onto a computer or the another programmable data processing device, so that a series of operations are performed on the computer or the another programmable device, thereby generating computer-implemented processing. Therefore, the instructions executed on the computer or the another programmable device provide operations for implementing a specified function in one or more processes in the flowcharts and/or in one or more blocks in the block diagrams.

Although exemplary embodiments of the present disclosure have been described, once persons skilled in the art know the basic creative concept, they can make additional changes and modifications to these embodiments. Therefore, the following claims are intended to be construed as to cover the exemplary embodiments and all changes and modifications falling within the scope of the present disclosure.

Obviously, a person skilled in the art can make various modifications and variations to the present disclosure without departing from the spirit and scope of the present disclosure. In this case, if the modifications and variations made to the present disclosure fall within the scope of the claims of the present disclosure and their equivalent technologies, the present disclosure is intended to include these modifications and variations.

What is claimed is:

1. A speech enhancement model training method, comprising:
obtaining a training sample set, each training sample comprising: a sample speech signal and a corresponding noise-containing speech signal, the noise-containing speech signal being obtained by adding noise based on the sample speech signal; and
performing iterative training on an initial speech enhancement model based on the training sample set for obtaining a trained speech enhancement model, the initial speech enhancement model comprising an input layer, a frequency band compression layer, a feature mapping layer, and an output layer, wherein each training comprising:
obtaining a first audio feature by respectively performing feature extraction on the sample speech signal and the corresponding noise-containing speech signal of a selected training sample through the input layer and then performing fusion;
obtaining a second audio feature by performing frequency band compression on the first audio feature through the frequency band compression layer, a quantity of feature dimensions of the second audio feature being less than a quantity of feature dimensions of the first audio feature;
obtaining a third audio feature by performing, through the feature mapping layer, feature mapping on the second audio feature by using a cyclic iteration manner until a number of iterations reaches a set number of instances of mapping, a quantity of output channels of the feature mapping layer progressively increasing in a cyclic iteration process; and
obtaining estimated gain information by inputting the third audio feature to the output layer, and performing parameter adjustment on the initial speech enhancement model based on a difference between the estimated gain information and corresponding true gain information.

2. The method according to claim 1, wherein the output layer comprises an intermediate convolutional network and an output convolutional network; and
obtaining estimated gain information by inputting the third audio feature to the output layer comprises:
convolving, through the intermediate convolutional network, the third audio feature by using the cyclic iteration manner until the number of iterations reaches a set number of instances of convolving, for obtaining an intermediate audio feature, wherein a quantity of output channels of the intermediate convolutional network remains unchanged in the cyclic iteration process; and
convolving, through the output convolutional network, the intermediate audio feature by using the cyclic iteration manner until the number of iterations reaches a set number of instances of outputting, for obtaining the estimated gain information, wherein a quantity of output channels of the output convolutional network progressively decreases in the cyclic iteration process.

3. The method according to claim 1, wherein the feature mapping layer comprises at least one layer of convolutional neural network and an attention mechanism network; and
obtaining the third audio feature by performing, through the feature mapping layer, feature mapping on the second audio feature by using the cyclic iteration manner until the number of iterations reaches the set number of instances of mapping comprises:
performing operations by cyclic iteration until the number of iterations reaches the set number of instances of mapping, wherein the operations comprise:
inputting the second audio feature to the at least one layer of convolutional neural network in sequence for convolving, for obtaining an intermediate convolutional feature;
inputting the intermediate convolutional feature to the attention mechanism network for feature interaction, for obtaining a new second audio feature; and
using the new second audio feature as the third audio feature.

4. The method according to claim 1, wherein both the sample speech signal and the noise-containing speech signal are frequency domain signals, and the first audio feature is a frequency domain feature; and
obtaining the second audio feature by performing frequency band compression on the first audio feature through the frequency band compression layer comprises:
transforming the first audio feature from a frequency domain into an acoustic perceptual scale domain, and dividing a transformed first audio feature into a set quantity of audio sub-features based on the acoustic perceptual scale domain; and
respectively inversely transforming the set quantity of audio sub-features from the acoustic perceptual scale domain into the frequency domain, and respectively filtering, through a band-pass filter, the inversely transformed audio sub-features of in frequency, for obtaining a second audio feature comprising the set quantity of frequency bands.

5. The method according to claim 1, wherein the estimated gain information comprises estimated gains of a set quantity of frequency bands; and
performing parameter adjustment on the initial speech enhancement model based on the difference between the estimated gain information and corresponding true gain information comprises:
performing frequency band decompression on the estimated gains of the set quantity of frequency bands, to obtain decompressed estimated gain information, the decompressed estimated gain information comprising estimated gains of frequencies of the noise-containing speech signal; and
performing the parameter adjustment on the initial speech enhancement model based on a difference between the decompressed estimated gain information and the corresponding true gain information.

6. The method according to claim 1, further comprising:
inputting a to-be-enhanced speech signal to a speech enhancement model; and
performing speech enhancement on the to-be-enhanced speech signal based on the estimated gain information, for removing noise from the to-be-enhanced speech signal and obtaining an enhanced speech signal.

7. The method according to claim 6, wherein the to-be-enhanced speech signal is obtained after an original speech signal is transformed from a time domain into a frequency domain, and the estimated gain information comprises estimated gains of a set quantity of frequency bands; and
performing speech enhancement on the to-be-enhanced speech signal based on the estimated gain information, for removing noise from the to-be-enhanced speech signal and obtaining the enhanced speech signal further comprises:
performing frequency band decompression on the estimated gains of the set quantity of frequency bands, for obtaining estimated gains of frequencies of the to-be-enhanced speech signal;
obtaining an initial enhanced speech signal based on the estimated gains of the frequencies and the to-be-enhanced speech signal; and
transforming the initial enhanced speech signal from the frequency domain into the time domain, for obtaining a final enhanced speech signal.

8. A speech enhancement model training apparatus, comprising a memory for storing instructions and a processor for executing the instructions, wherein the processor is configured to:
obtain a training sample set, each training sample comprising: a sample speech signal and a corresponding noise-containing speech signal, the noise-containing speech signal being obtained by adding noise based on the sample speech signal; and
perform iterative training on an initial speech enhancement model based on the training sample set, for obtaining a trained speech enhancement model, the initial speech enhancement model comprising an input layer, a frequency band compression layer, a feature mapping layer, and an output layer, wherein, for each training process, the processor is configured to:
obtain a first audio feature by respectively performing feature extraction on the sample speech signal and the corresponding noise-containing speech signal of a selected training sample through the input layer, and then performing fusion;
obtain a second audio feature by performing frequency band compression on the first audio feature through the frequency band compression layer, a quantity of feature dimensions of the second audio feature being less than a quantity of feature dimensions of the first audio feature;
obtain a third audio feature by performing, through the feature mapping layer, feature mapping on the second audio feature by using a cyclic iteration manner until a number of iterations reaches a set number of instances of mapping, a quantity of output channels of the feature mapping layer progressively increasing in a cyclic iteration process; and
obtain estimated gain information by inputting the third audio feature to the output layer, and perform parameter adjustment on the initial speech enhancement model based on a difference between the estimated gain information and corresponding true gain information.

9. The speech enhancement model training apparatus of claim 8, comprising a memory for storing instructions and a processor for executing the instructions, wherein the output layer comprises an intermediate convolutional network and an output convolutional network; and
wherein the processor, being configured to obtain estimated gain information by inputting the third audio feature to the output layer, is further configured to:
convolve, through the intermediate convolutional network, the third audio feature by using the cyclic iteration manner until the number of iterations reaches a set number of instances of convolving, for obtaining an intermediate audio feature, wherein a quantity of output channels of the intermediate convolutional network remains unchanged in the cyclic iteration process; and
convolve, through the output convolutional network, the intermediate audio feature by using the cyclic iteration manner until the number of iterations reaches a set number of instances of outputting, for obtaining the estimated gain information, wherein a quantity of output channels of the output convolutional network progressively decreases in the cyclic iteration process.

10. The speech enhancement model training apparatus of claim 8, comprising a memory for storing instructions and a processor for executing the instructions, wherein the feature mapping layer comprises at least one layer of convolutional neural network and an attention mechanism network; and
wherein the processor, being configured to obtain the third audio feature by performing, through the feature mapping layer, feature mapping on the second audio feature by using the cyclic iteration manner until the number of iterations reaches the set number of instances of mapping, is further configured to:
perform operations by cyclic iteration until the number of iterations reaches the set number of instances of mapping, wherein the operations comprise:
inputting the second audio feature to the at least one layer of convolutional neural network in sequence for convolving, to obtain an intermediate convolutional feature;
inputting the intermediate convolutional feature to the attention mechanism network for feature interaction, to obtain a new second audio feature; and
using the new second audio feature as the third audio feature.

11. The speech enhancement model training apparatus of claim 8, comprising a memory for storing instructions and a processor for executing the instructions, wherein both the sample speech signal and the noise-containing speech signal are frequency domain signals, and the first audio feature is a frequency domain feature; and
wherein the processor, being configured to obtain the second audio feature by performing frequency band compression on the first audio feature through the frequency band compression layer, is further configured to:
transform the first audio feature from a frequency domain into an acoustic perceptual scale domain, and divide a transformed first audio feature into a set quantity of audio sub-features based on the acoustic perceptual scale domain; and
respectively inversely transform the set quantity of audio sub-features from the acoustic perceptual scale domain into the frequency domain, and respectively filter, through a band-pass filter, the inversely transformed audio sub-features in frequency, to obtain a second audio feature comprising the set quantity of frequency bands.

12. The speech enhancement model training apparatus of claim 8, comprising a memory for storing instructions and a processor for executing the instructions, wherein the estimated gain information comprises estimated gains of a set quantity of frequency bands; and
wherein the processor, being configured to perform parameter adjustment on the initial speech enhancement model based on the difference between the estimated gain information and corresponding true gain information, is further configured to:
perform frequency band decompression on the estimated gains of the set quantity of frequency bands, to obtain decompressed estimated gain information, the decompressed estimated gain information comprising estimated gains of frequencies of the noise-containing speech signal; and
perform the parameter adjustment on the initial speech enhancement model based on a difference between the decompressed estimated gain information and the corresponding true gain information.

13. The speech enhancement model training apparatus of claim 8, comprising a memory for storing instructions and a processor for executing the instructions, wherein the processor is further configured to:
input a to-be-enhanced speech signal to a speech enhancement model; and
perform speech enhancement on the to-be-enhanced speech signal based on the estimated gain information, for removing noise from the to-be-enhanced speech signal and obtaining an enhanced speech signal.

14. The speech enhancement model training apparatus of claim 13, comprising a memory for storing instructions and a processor for executing the instructions, wherein the to-be-enhanced speech signal is obtained after an original speech signal is transformed from a time domain into a frequency domain, and the estimated gain information comprises estimated gains of a set quantity of frequency bands; and
wherein the processor, being configured to perform speech enhancement on the to-be-enhanced speech signal based on the estimated gain information, for removing noise from the to-be-enhanced speech signal and obtaining the enhanced speech signa, the processor is further configured to:
perform frequency band decompression on the estimated gains of the set quantity of frequency bands, for obtaining estimated gains of frequencies of the to-be-enhanced speech signal;
obtain an initial enhanced speech signal based on the estimated gains of the frequencies and the to-be-enhanced speech signal; and
transform the initial enhanced speech signal from the frequency domain into the time domain, for obtaining a final enhanced speech signal.

15. A non-transitory computer readable medium storing a plurality of instructions, wherein the plurality of instructions, when executed by a processor, configure the processor to:
obtain a training sample set, each training sample comprising: a sample speech signal and a corresponding noise-containing speech signal, the noise-containing speech signal being obtained by adding noise based on the sample speech signal; and
perform iterative training on an initial speech enhancement model based on the training sample set, for obtaining a trained speech enhancement model, the initial speech enhancement model comprising an input layer, a frequency band compression layer, a feature mapping layer, and an output layer, wherein, for each training process, the processor is configured to:
obtain a first audio feature by respectively performing feature extraction on the sample speech signal and the corresponding noise-containing speech signal of a selected training sample through the input layer, and then performing fusion;
obtain a second audio feature by performing frequency band compression on the first audio feature through the frequency band compression layer, a quantity of feature dimensions of the second audio feature being less than a quantity of feature dimensions of the first audio feature;
obtain a third audio feature by performing, through the feature mapping layer, feature mapping on the second audio feature by using a cyclic iteration manner until a number of iterations reaches a set number of instances of mapping, a quantity of output channels of the feature mapping layer progressively increasing in a cyclic iteration process; and
obtain estimated gain information by inputting the third audio feature to the output layer, and perform parameter adjustment on the initial speech enhancement model based on a difference between the estimated gain information and corresponding true gain information.

16. The non-transitory computer readable medium storing a plurality of instructions of claim 15, wherein the output layer comprises an intermediate convolutional network and an output convolutional network; and
wherein the plurality of instructions, when executed by a processor, configure the processor to obtain estimated gain information by inputting the third audio feature to the output layer, further configure the processor to:
convolve, through the intermediate convolutional network, the third audio feature by using the cyclic iteration manner until the number of iterations reaches a set number of instances of convolving, for obtaining an intermediate audio feature, wherein a quantity of output channels of the intermediate convolutional network remains unchanged in the cyclic iteration process; and
convolve, through the output convolutional network, the intermediate audio feature by using the cyclic iteration manner until the number of iterations reaches a set number of instances of outputting, for obtaining the estimated gain information, wherein a quantity of output channels of the output convolutional network progressively decreases in the cyclic iteration process.

17. The non-transitory computer readable medium storing a plurality of instructions of claim 15, wherein the feature mapping layer comprises at least one layer of convolutional neural network and an attention mechanism network; and
wherein the plurality of instructions, when executed by a processor, configure the processor to obtain the third audio feature by performing, through the feature mapping layer, feature mapping on the second audio feature by using the cyclic iteration manner until the number of iterations reaches the set number of instances of mapping, further configure the processor to:
perform operations by cyclic iteration until the number of iterations reaches the set number of instances of mapping, wherein the operations comprise:
inputting the second audio feature to the at least one layer of convolutional neural network in sequence for convolving, to obtain an intermediate convolutional feature;
inputting the intermediate convolutional feature to the attention mechanism network for feature interaction, to obtain a new second audio feature; and
using the new second audio feature as the third audio feature.

18. The non-transitory computer readable medium storing a plurality of instructions of claim 15, wherein both the sample speech signal and the noise-containing speech signal are frequency domain signals, and the first audio feature is a frequency domain feature; and
wherein the plurality of instructions, when executed by a processor, configure the processor to obtain the second audio feature by performing frequency band compression on the first audio feature through the frequency band compression layer, further configure the processor to:
transform the first audio feature from a frequency domain into an acoustic perceptual scale domain, and divide a transformed first audio feature into a set quantity of audio sub-features based on the acoustic perceptual scale domain; and
respectively inversely transform the set quantity of audio sub-features from the acoustic perceptual scale domain into the frequency domain, and respectively filter, through a band-pass filter, the inversely transformed audio sub-features in frequency, to obtain a second audio feature comprising the set quantity of frequency bands.

19. The non-transitory computer readable medium storing a plurality of instructions of claim 15, wherein the estimated gain information comprises estimated gains of a set quantity of frequency bands; and
wherein the plurality of instructions, when executed by a processor, configure the processor to perform parameter adjustment on the initial speech enhancement model based on the difference between the estimated gain information and corresponding true gain information, further configure the processor to:
perform frequency band decompression on the estimated gains of the set quantity of frequency bands, to obtain decompressed estimated gain information, the decompressed estimated gain information comprising estimated gains of frequencies of the noise-containing speech signal; and
perform the parameter adjustment on the initial speech enhancement model based on a difference between the decompressed estimated gain information and the corresponding true gain information.

20. The non-transitory computer readable medium storing a plurality of instructions of claim 15, wherein the plurality of instructions, when executed by a processor, further configure the processor to:
input a to-be-enhanced speech signal to a speech enhancement model; and
perform speech enhancement on the to-be-enhanced speech signal based on the estimated gain information, for removing noise from the to-be-enhanced speech signal and obtaining an enhanced speech signal.
